(19) United States
(12) Patent Application Publication
(10) Pub. No.: US 2008/0195485 A1
(43) Pub. Date: Aug. 14, 2008

(54) Prepaid foreign currency transaction platform

(75) Inventor: Thomas John Kennedy, Broomall, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: Waves Licensing, LLC

(21) Appl. No.: 12/008,046

(22) Filed: Jan. 8, 2008

Related U.S. Application Data
(60) Provisional application No. 60/900,620, filed on Feb. 9, 2007.

(51) Int. Cl. G06Q 20/00; G06Q 40/00; G06Q 30/00

(52) U.S. Cl. 705/14; 705/41; 705/30

(57) ABSTRACT

Computer-implemented systems and methods for a consumer to make transactions in a foreign currency at a predetermined exchange rate, comprising enabling a consumer to prepay an issuer for a selected quantity of a foreign currency at a prepaid exchange rate determined by the issuer; issuing to the consumer a foreign currency debit card that identifies the consumer and indicates an amount of the foreign currency owed by the issuer to the consumer for use in foreign currency transactions made using the foreign currency debit card; enabling the consumer to conduct at least one transaction with a vendor in an amount of the foreign currency not to exceed the selected amount; paying the foreign currency in the amount of the transaction to the vendor; and reducing the selected quantity of the foreign currency owed to the consumer by the amount of the transaction.

### CROSS REFERENCE TO RELATED APPLICATIONS

Reference is made to and priority claimed from U.S. Provisional Application No. 60/900,620, filed Feb. 9, 2007, which is incorporated herein by reference.

### BACKGROUND

International travelers and others who want to conduct transactions in foreign currencies are limited in the options available to them. One option is for the traveler to exchange a desired amount of domestic currency for a foreign currency before traveling, and carry the foreign currency. This provides the benefit of not being subject to exchange rate risk, or subject to unpredictably large fees associated with converting money as needed when traveling. However, if the desired amount is large, the traveler is left with the undesirable necessity of being in possession of a large amount of foreign cash. Alternatively, a traveler may choose to use a credit card when traveling in a foreign country to avoid carrying a large amount of cash. However, credit card purchases are accorded an exchange rate based on the spot exchange rate at the time of each purchase. The traveler is thus exposed to exchange rate risk. In addition, conversion fees associated with converting currencies, including using credit cards, may be large. Alternatively, a traveler can also use an automated teller machine (ATM) card, whereby the traveler can access a bank account in order to make cash withdrawals. However, using an ATM card results in many of the same risks and concerns as using a credit card.

From the foregoing it is appreciated that there exists a need for a new platform that ameliorates the shortcomings of existing practices.

### SUMMARY

The herein described methods and systems provide a computer-implemented foreign currency transaction platform that allows travelers and others to make purchases in a foreign currency using a prepaid foreign currency debit card, instead of cash, without being subject to unpredictable currency exchange fees, and without being subject to exchange rate fluctuations.

In an illustrative implementation, a consumer prepays an issuer using a domestic currency for a select amount of a foreign currency at a determined consumer exchange rate. The consumer exchange rate may be based on: 1) the spot currency exchange rate; 2) an issuer exchange rate; or 3) a combination of the two. The issuer exchange rate may be the spot market currency exchange rate or may be an exchange rate provided to the issuer by a bank, which is based on the spot market exchange rate. In the illustrative implementation, the consumer can receive a foreign currency debit card from the issuer for identifying the consumer and indicating the amount of foreign currency owed to the consumer by the issuer. The consumer may also pay to the issuer a service fee associated with the purchase of the prepaid foreign currency debit card.

In an illustrative operation, the consumer makes a transaction using the foreign currency debit card, such as making a purchase from a vendor in a foreign country that uses the foreign currency. The purchase can be for an amount equal to at least a portion of the foreign currency for which the consumer has prepaid. The amount of foreign currency owed to the consumer is reduced by the amount of the purchase. In addition, information can be provided or generated based on foreign currency transactions, such as for use in one or more customer programs such as marketing programs directed at the consumer, in response to receiving payment for the foreign currency and/or using the prepaid foreign currency debit card to make purchases. The consumer can then receive a benefit in accordance with the customer program. In addition, the information can be used in one or more vendor programs such as marketing programs directed at a vendor, in response to registering or otherwise setting up to use the foreign currency transaction platform, and/or accepting the consumer's prepaid foreign currency debit card to receive payment for consumer purchases. The vendor can then receive a benefit in accordance with the vendor program.

In an exemplary implementation, a system for providing prepaid foreign currency to a consumer can comprise a currency debit card for storing consumer information, a card reader for reading the consumer information, a cash register or other input device such as a keypad to input the amount in the foreign currency of a purchase made in the foreign currency by the consumer, a transmitter operatively associated with the card reader and the input device for sending the consumer information and amount of the purchase to a server. The server has a receiver, and is arranged or configured to receive the consumer information and amount of the purchase, keep an accounting of purchases made by the consumer, and process the consumer and purchase information in accordance with at least one customer program, such as a marketing program directed to the consumer.

Other features of the herein described systems and methods are further described below.

### BRIEF DESCRIPTION OF THE DRAWINGS

The methods and system for a prepaid foreign currency transaction platform are further described with reference to the accompanying drawings in which:

FIG. 1 is a block diagram of an exemplary computing environment in accordance with an implementation of the herein described systems and methods;

FIG. 2 is a block diagram showing the cooperation of exemplary components of an illustrative implementation in accordance with the herein described systems and methods;

FIG. 3 is a flow diagram showing the cooperation of exemplary market participants of an illustrative implementation of a prepaid foreign currency transaction platform in accordance with the herein described systems and methods;

FIG. 4 is a block diagram showing the cooperation of exemplary components of an illustrative implementation of a prepaid foreign currency transaction platform in accordance with the herein described systems and methods; and

FIG. 5 is a flow diagram showing exemplary processing performed to allow for prepaid foreign currency transactions in accordance with the herein described systems and methods

### DETAILED DESCRIPTION

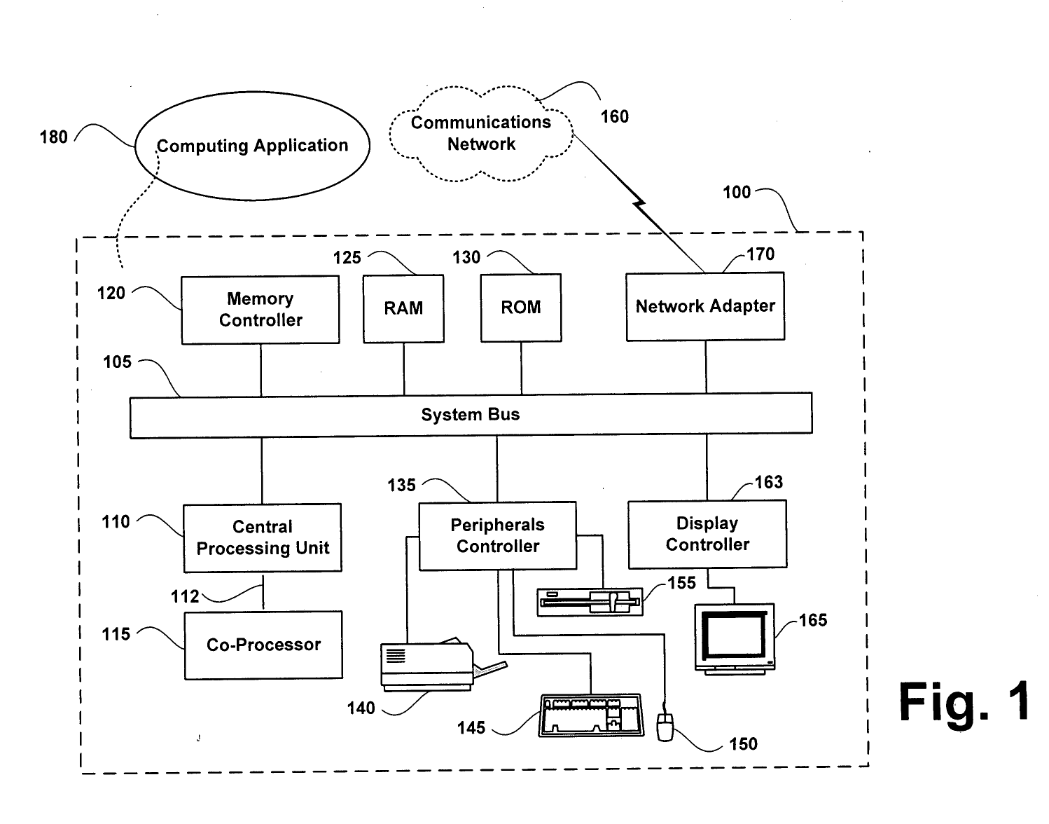

FIG. 1 depicts an exemplary computing system 100 in accordance with herein described system and methods. The computing system 100 is capable of executing a variety of computing applications 180. Computing application 180 can comprise a computing application, a computing applet, a computing program. or other instruction set operative on computing system 100 to perform at least one function, operation, and/or procedure. Exemplary computing system 100 is controlled primarily by computer readable instructions, which may be in the form of software. The computer readable instructions can contain instructions for computing system 100 for storing and accessing the computer readable instructions themselves. Such software may be executed within central processing unit (CPU) 110 to cause the computing system 100 to perform desired functions. In many known computer servers, workstations and personal computers CPU 110 is implemented by micro-electronic chips CPUs called microprocessors. A co-processor 115 is an optional processor, distinct from the main CPU 110 that performs additional functions or assists the CPU 110. The CPU 110 may be connected to co-processor 115 through interconnect 112. One common type of coprocessor is the floating-point coprocessor, also called a numeric or math coprocessor, which is designed to perform numeric calculations faster and better than the general-purpose CPU 110.

In operation, the CPU 110 fetches, decodes, and executes instructions, and transfers information to and from other resources via the computer's main data-transfer path, system bus 105. Such a system bus connects the components in the computing system 100 and defines the medium for data exchange. Memory devices coupled to the system bus 105 include random access memory (RAM) 125 and read only memory (ROM) 130. Such memories include circuitry that allows information to be stored and retrieved. The ROMs 130 generally contain stored data that cannot be modified. Data stored in the RAM 125 can be read or changed by CPU 110 or other hardware devices. Access to the RAM 125 and/or ROM 130 may be controlled by memory controller 120. The memory controller 120 may provide an address translation function that translates virtual addresses into physical addresses as instructions are executed.

In addition, the computing system 100 can contain peripherals controller 135 responsible for communicating instructions from the CPU 110 to peripherals, such as, printer 140, keyboard 145, mouse 150, and data storage drive 155. Display 165, which is controlled by a display controller 163, is used to display visual output generated by the computing system 100. Such visual output may include text, graphics, animated graphics, and video. The display controller 163 includes electronic components required to generate a video signal that is sent to display 165. Further, the computing system 100 can contain network adaptor 170 which may be used to connect the computing system 100 to an external communications network 160.

### Illustrative Computer Network Environment:

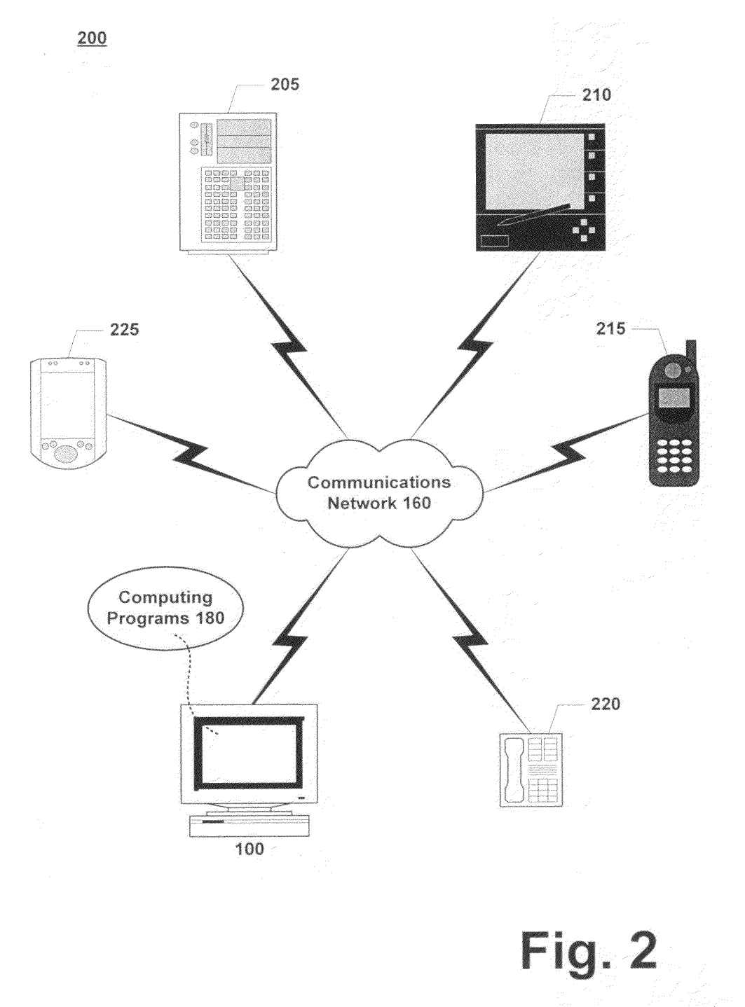

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2, server 205 may be interconnected via a communications network 160 (which may be either of, or a combination of a fixed-wire or wireless LAN, WAN, intranet, extranet, peer-to-peer network, virtual private network, the Internet, or other communications network) with a number of client computing environments such as tablet personal computer 210, mobile telephone 215, telephone 220, personal computer 100, and personal digital assistant 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Additionally, networked computing environment 200 can utilize various data security protocols such as secured socket layer (SSL) or pretty good privacy (PGP). Each client computing environment 100, 210, 215, 220, and 225 can be equipped with operating system 180 operable to support one or more computing applications, such as a web browser (not shown), or other graphical user interface (not shown), or a mobile desktop environment (not shown) to gain access to server computing environment 205.

In operation, a user (not shown) may interact with a computing application running on a client computing environment to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication data and applications and may cooperate with other server computing environments (not shown), third party service providers (not shown), network attached storage (NAS) and storage area networks (SAN) to realize application/data transactions.

### Prepaid Foreign Currency Transactions:

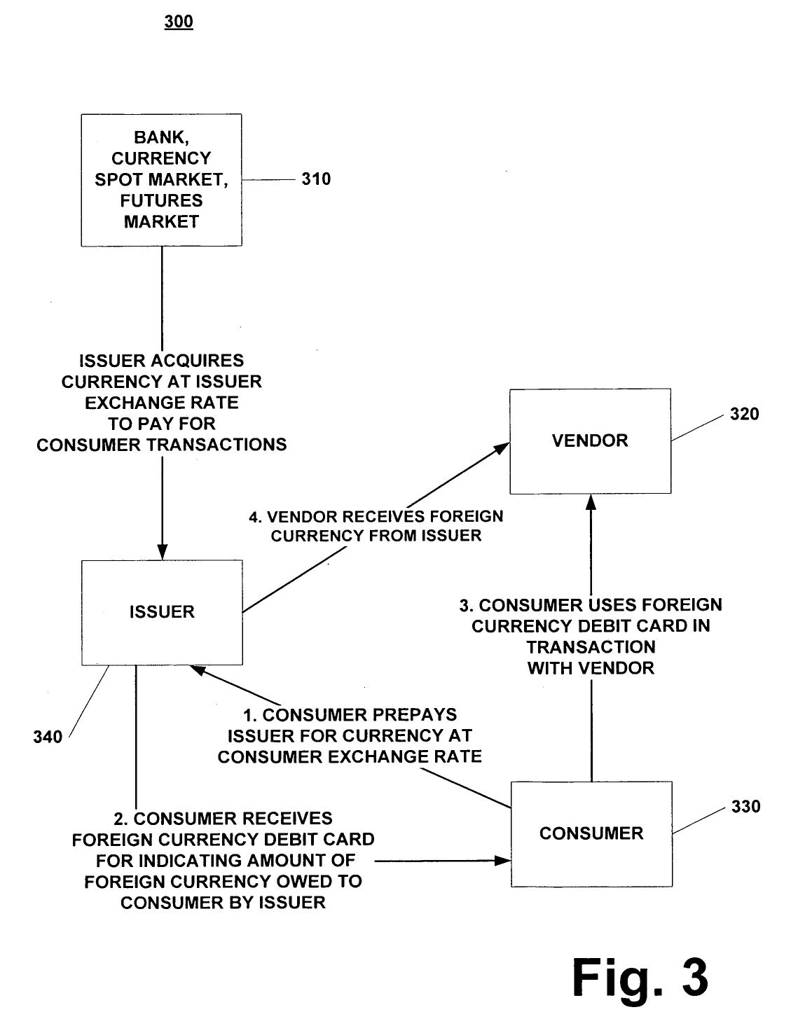

FIG. 3 shows the cooperation of exemplary market participants of an illustrative implementation of a prepaid foreign currency transaction platform. For the purpose of illustration, foreign currency is shown supplied based on the spot currency market or a derivative market such as a futures market 310 to a new market participant, herein arbitrarily designated for purposes of illustration an “issuer” 340.

As is shown in FIG. 3, in step 1, the consumer 330 prepays issuer 340 for a predetermined amount of foreign currency at a fixed consumer exchange rate. The fixed consumer exchange rate can be a spot market exchange rate plus an adjustment, such as the spot market rate plus a price risk premium. The consumer may also pay the issuer a predetermined currency exchange fee, such as a fixed amount or a percentage of the amount exchanged. The issuer 340 provides a prepaid foreign currency debit account for the consumer 330, representative of the amount of foreign currency for which the consumer had prepaid the issuer at the consumer exchange rate. The debit account can be provided for the consumer in conjunction with a prepaid foreign currency debit card, for indicating the amount of foreign currency for which the consumer has prepaid at the consumer exchange rate, as shown by step 2. In an exemplary operation, in step 3 the consumer 330 makes a transaction with a vendor 320, such as when in a foreign country wherein the foreign currency is used, by using the debit card to make a purchase from the vendor 320. In the exemplary operation, in step 4 the vendor receives foreign currency from the issuer for the purchase. Optionally, the issuer can charge the vendor a fee, such as by retaining a fixed service charge or a percentage of the value of the transaction. Alternatively, the consumer 330 can make a cash withdrawal, such as from a bank or automated teller machine (ATM) in the foreign country. The consumer's prepaid foreign currency debit account is debited for the amount of the purchase or withdrawal. Further, the issuer can hedge exchange rate risk using currency exchange derivatives such as futures and/or swaps.

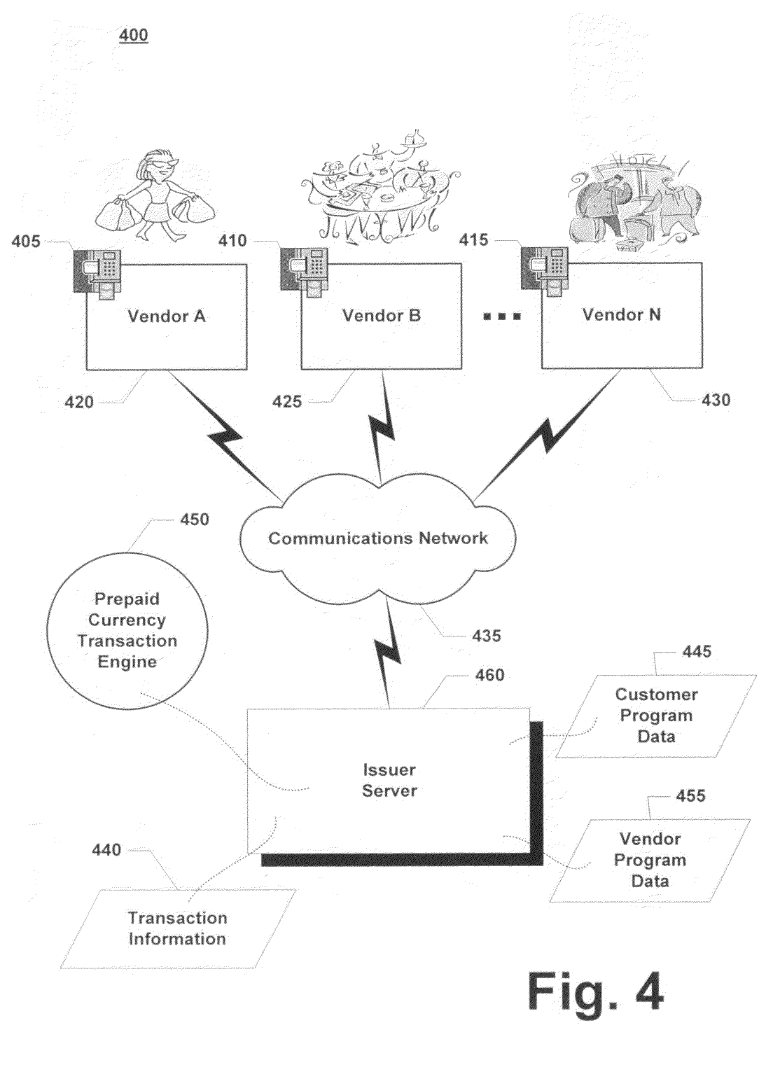

FIG. 4 shows an illustrative implementation of exemplary prepaid foreign currency transaction platform 400, such as would be used for retail transactions. As is shown in FIG. 4, exemplary prepaid foreign currency transaction platform 400 comprises one or more vendors, such as Vendor A 420, Vendor B 425 up to and including Vendor N 430, communications network 435, issuer server computing environment 460, prepaid foreign currency transaction engine 450, data storage containing transaction data 440, and data storage containing customer program data 445 and vendor program data 455. Also, as is shown in FIG. 4, prepaid foreign currency transaction platform comprises card readers 405, 410, and 415, shown reading consumer foreign currency debit cards, associated with Vendors 420, 425, and 430, respectively. Communications network 435 can comprise one or more of fixed-wire and/or wireless intranets, extranets, and/or the Internet.

In an illustrative operation, a consumer uses his foreign currency debit card with a card reader associated with a vendor when making a purchase, to identify the prepaid currency account that will be debited for the purchase. The vendor then uses a cash register or keypad to enter the amount of the purchase (not shown). A transmitter operatively associated with the card reader, cash register or keypad (not shown), communicates the consumer identifying information and amount of the purchase to server computing environment 460 over communications network 435. In the illustrative operation, prepaid currency transaction engine 450 can operate on issuer server 460 to provide one or more instructions to issuer server 460 to debit a prepaid consumer foreign currency account, to keep an accounting of the foreign currency paid for and used by the consumer for purchases. The consumer's debit account information and transaction data (collectively “transaction information”) can be stored in transaction information storage 440. In addition, prepaid foreign currency transaction engine 450 can operate on server computing environment 460 to provide processing in support of one or more customer programs using customer program data stored in customer program data storage 445. Such programs can include, for example, marketing programs directed to consumers. Optionally, vendor programs, such as marketing programs, can also be provided for participating vendors using Vendor program data 455.

In illustrative implementations, exemplary programs can include discounts, points, or special offers for additional products and/or services, such as offers directed to the consumer by the issuer, the vendor, and/or an affiliate, or the like.

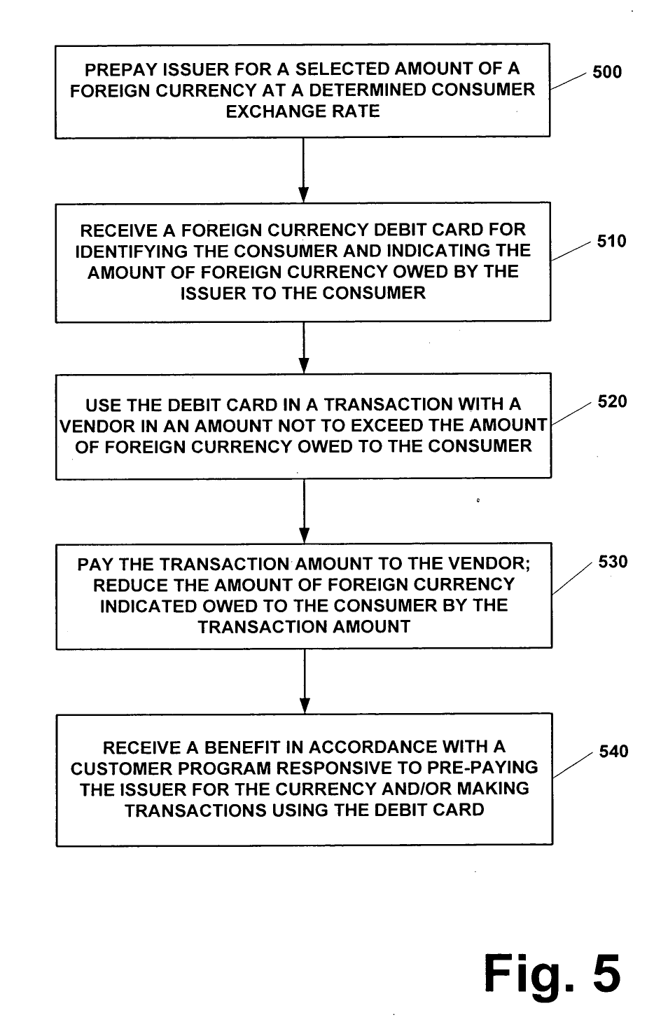

FIG. 5 shows exemplary steps performed when using an illustrative implementation of prepaid foreign currency transaction platform for retail transactions 400 of FIG. 4. As is shown, processing begins at block 500 where a consumer prepays an issuer for a select amount of foreign currency at a determined consumer exchange rate. The consumer receives a foreign currency debit card for identifying the consumer and indicating the amount of foreign currency owed by the issuer to the consumer, 510. The amount of foreign currency owed by the issuer to the consumer can be stored on the card, or at another location, such as transaction data storage 440 (of FIG. 4). The consumer uses the debit card to make a purchase in an amount of at least a portion of the foreign currency paid for, 520. The consumer makes a purchase from a vendor which uses a card reader to read the consumer identifying information from the debit card. Other means can alternatively be used to identify the consumer, such as using a keyboard to type in the identifying information, a FOB wand, a mobile phone, or other electronic payment means. The amount of the purchase is provided to the issuer by the vendor using a cash register or keypad (not shown), and the issuer pays the purchase amount to the vendor, optionally reduced by a vendor service fee, and the amount of currency indicated owed by the issuer to the consumer is reduced by the amount of the purchase, 530. Optionally, the consumer can receive a benefit in accordance with a customer program, 540. The benefit can be received responsive to the consumer pre-paying for the foreign currency, and/or responsive to the consumer using the debit card to make purchases from participating vendors.

It is appreciated that although the cooperating parties of described in FIGS. 3-5 are shown to have distinct roles that such description is merely illustrative as the inventive concepts described herein contemplate the cooperation of various parties having combined roles. For example, in the illustrative implementations described in FIGS. 3-5, the issuer and vendor are described as separate entities. The inventive concepts described herein contemplate illustrative implementations in which the issuer and vendor are the same party.

It is understood that the herein described systems and methods are susceptible to various modifications and alternative constructions. There is no intention to limit the herein described systems and methods to the specific constructions described herein. On the contrary, the herein described systems and methods are intended to cover all modifications, alternative constructions, and equivalents falling within the scope and spirit of the herein described systems and methods.

It should also be noted that the herein described systems and methods can be implemented in a variety of electronic environments (including both wired and wireless networked environments), partial computing environments, and other real world environments. The various techniques described herein may be implemented in hardware or software, or a combination of both. Preferably, the techniques are implemented in computing environments maintaining programmable computers that include a computer network, processor, servers, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although exemplary implementations of the herein described systems and methods have been described in detail above, those skilled in the art will readily appreciate that many additional modifications are possible in the exemplary embodiments without materially departing from the novel teachings and advantages of the herein described systems and methods. Accordingly, these and all such modifications are intended to be included within the scope of the herein described systems and methods. The herein described systems and methods may be better defined by the following exemplary claims.

What is claimed is:

1. A method for a consumer to make transactions in a foreign currency at a predetermined exchange rate, comprising:
enabling a consumer to prepay an issuer for a selected quantity of a foreign currency at a prepaid exchange rate determined by the issuer;
issuing to the consumer a foreign currency debit card that identifies the consumer and indicates an amount of the foreign currency owed by the issuer to the consumer for use in foreign currency transactions made using the foreign currency debit card;
enabling the consumer to conduct at least one transaction with a vendor in an amount of the foreign currency not to exceed the selected amount;
paying the foreign currency in the amount of the transaction to the vendor; and
reducing the quantity of the foreign currency owed to the consumer by the amount of the transaction.

2. The method of claim 1, wherein the foreign currency transaction is a purchase or a cash withdrawal.

3. The method of claim 1, further comprising charging the vendor a vendor fee for the transaction.

4. The method of claim 1, further comprising:
providing a benefit to at least one of the consumer and the vendor in accordance with a benefit program responsive to the consumer's transaction in the foreign currency using the foreign currency debit card.

5. The method of claim 1, wherein the vendor is also the issuer.

6. The method of claim 1, further comprising:
calculating the prepaid foreign currency exchange rate based on a spot exchange rate at the time of the consumer pre-paying the issuer.

7. The method of claim 1, wherein information pertaining to the quantity of foreign currency owed to the consumer is stored on the foreign currency debit card.

8. The method of claim 1, wherein information pertaining to the quantity of foreign currency owed to the consumer is stored on a server.

9. A computer readable medium having computer readable instructions to instruct a computer to perform a method comprising:
receiving from a vendor information pertaining to a foreign currency transaction between the vendor and a consumer using a prepaid foreign currency debit card issued by an issuer, the information including consumer identifying information and the amount of the transaction in the foreign currency;
paying the vendor the value of the transaction in the foreign currency; and
reducing a prepaid quantity of foreign currency indicated owed to the consumer by the amount of the transaction in the foreign currency.

10. The computer readable medium of claim 9, the method further comprising:
reducing the payment to the vendor by an amount of a vendor fee for the transaction.

11. The computer readable medium of claim 9, the method further comprising:
determining a benefit to be provided to at least one of the consumer and the vendor in accordance with a customer program, responsive to the foreign currency transaction using the prepaid foreign currency debit card.

12. A system for a consumer to make transactions in a foreign currency at a predetermined exchange rate, comprising:
a prepaid foreign currency debit card having consumer information;
a card reader for reading the consumer information;
an input device for inputting the amount of a foreign currency transaction;
a transmitter for sending foreign currency transaction information pertaining to the foreign currency transaction made using the foreign currency debit card, including the consumer information and the transaction amount in the foreign currency;
a communications network for conveying the foreign currency transaction information; and
a server arranged with a receiver for receiving the foreign currency transaction information and for storing a consumer prepaid foreign currency account for indicating a quantity of prepaid foreign currency owed to the consumer, the server arranged to provide payment to the vendor in the foreign currency in the amount of the transaction, and to reduce the quantity of prepaid foreign currency by the amount of the foreign currency transaction.

13. The system of claim 12, wherein the server is arranged to reduce the payment to the vendor by an amount of a vendor service fee.

14. The system of claim 12, further comprising:
a prepaid foreign currency transaction engine for keeping an accounting of the prepaid foreign currency balance owed to the consumer.

15. The system of claim 12, further comprising:
transaction information storage for storing consumer foreign currency debit account information and transaction information.

16. The system of claim 12, further comprising:
customer program data storage for storing customer program data for use in one or more customer programs directed to at least one of consumers and vendors.

17. The system of claim 16, wherein the customer programs include at least one of a marketing program, a discount, an award of points, and a special offer for additional products or services.

18. The system of claim 17, wherein the offers are provided by at least one of the issuer, the vendor, and an affiliate.

19. The system of claim 12, wherein the communications network comprises at least one of a wired network and a wireless network.
